(19) United States
(12) Patent Application Publication
(10) Pub. No.: US 2026/0140504 A1
(43) Pub. Date: May 21, 2026

(54) MODULAR AUTOMATED STORAGE AND RETRIEVAL SYSTEMS AND METHODS

(71) Applicant: Instock, Inc., San Carlos, CA (US)

(72) Inventors: Mykola Blokhin, Rovinka (SK); Pavlo Kapyshin, Baryshivka (UA); Viktoriia Petrunets, Bratislava (SK); Andrii Shvydkyi, Kyiv (UA); Yegor Anchyshkin, San Carlos, CA (US)

(73) Assignee: Instock, Inc., San Carlos, CA (US)

(21) Appl. No.: 19/124,072

(22) PCT Filed: Nov. 3, 2023
(86) PCT No.: PCT/US2023/078629

§ 371 Date: Apr. 24, 2025

Related U.S. Application Data
(60) Provisional application No. 63/422,721, filed on Nov. 4, 2022.

(51) Int. Cl. G05D 1/246; G01C 21/00; G05D 101/00; G05D 107/70

(52) U.S. Cl. CPC G05D 1/2465; G01C 21/383; G05D 2101/22; G05D 2107/70

(57) ABSTRACT

Methods and systems for use with an automated storage and retrieval system (ASRS) are described. In some embodiments, a model may be generated using a simplified three dimensional model of the storage facility where the model may include functionalized interconnected volumes and/or surfaces. During operation, an ASRS may include at least one robot, which can move along surfaces, hold a payload (e.g., containers, objects, etc.), and interact with the environment of the storage facility to facilitate movement and handling of the payload within the storage facility. In some embodiments, the robot may obtain and use a map of the storage facility that is generated using the disclosed models for controlling operation of the robot based at least in part on a location of the robot within the storage facility and the functionality of that location defined in the map of the storage facility.

### CROSS-REFERENCE TO RELATED APPLICATIONS

This application claims the benefit of priority under 35 U.S.C. § 119(e) of U.S. Provisional Application Ser. No. 63/422,721, filed Nov. 4, 2022, which is incorporated herein by reference in its entirety.

### FIELD

Disclosed embodiments are related to modular automated storage and retrieval systems and methods.

### BACKGROUND

Robots and robotic systems may be used for transporting payloads within warehouses and other environments. Typical systems use a rigid predefined arrangement of structures and areas with predefined uses for controlling the robots and robotic systems in such an application.

### SUMMARY

In one aspect, a method for generating a model of a storage facility includes obtaining a three-dimensional model of the storage facility, defining a plurality of interconnected surface within the three-dimensional model, and then assigning one or more functionalities to the plurality of interconnected surfaces. The one or more functionalities may include at least one selected from a drivable space, container storage, container handling, and a user workstation. A map may be generated for use by one or more robots based at least in part on the plurality of interconnected surfaces and the one or more functionalizes. The plurality of interconnected surfaces may be further segmented into a plurality of surface segments and one or more boundaries disposed between adjacent surface segments. A plurality of interconnected volumes may also be defined within the three-dimensional model corresponding void space within the model, and the plurality of interconnected volumes may be partitioned into separate partitioned volumes. One or more functionalities may be assigned to the plurality of interconnected volumes, where the functionalities include at least one selected from a drivable space, container storage, container handling, and a user workstation.

In another aspect, a method for controlling operation of a robot in a storage facility includes obtaining a map including information related to a plurality of interconnected surfaces located in the storage facility with their assigned functionalities, determining a location of the robot within the storage facility, identifying an interconnected surface the robot is located on based at least in part on the determined location and the map, and controlling operation of the robot based at least in part on the determined location and a functionality of the identified interconnected surface the robot is located on. The plurality of interconnected surfaces may include a plurality of separate surface segments with separately defined functionalities, wherein one or more boundaries are disposed between adjacent surface segments. The assigned functionalities may include at least one selected from drivable space, container storage, container handling, and a user workstation. The map may be generated based at least in part on a three-dimensional model of the storage facility and may be downloaded to the robot from a remotely located server. In one embodiment, the map may be generated on the robot. In another embodiment, the map may be generated on a remotely located server. One or more processors perform the methods above when non-transitory computer readable memory including directions.

In one embodiment, a robot comprises a locomotion system configured to move the robot along a surface, a retainer constructed and arranged to hold a payload, and a controller comprising a processor. The controller may obtain a map including information related to a plurality of interconnected surfaces with assigned functionalities located in the storage facility, determine a location of the robot within the storage facility, identify an interconnected surface the robot is located on based at least in part on the determined location and the map, and control operation of the robot based at least in part on the determined location and a functionality of the identified interconnected surface the robot is located on.

The plurality of interconnected surfaces may include a plurality of separate surface segments with separately defined functionalities, wherein one or more boundaries are disposed between adjacent surface segments. The assigned functionalities may include at least one selected from drivable space, container storage, container handling, and a user workstation. The map may be generated by the controller based at least in part on a three-dimensional model of the storage facility and the controller may download the map to the robot from a remotely located server. The map may be stored on non-transitory computer readable memory on the robot.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1A is a perspective view of a robot, according to one embodiment;

FIG. 1B is an interior view of the robot of FIG. 1A;

FIG. 2A is a side view of a robot on a horizontal surface, according to one embodiment;

FIG. 2B is a side view of the robot of FIG. 2A moving onto an inclined surface;

FIG. 2C is a side view of the robot of FIG. 2A moving further onto the inclined surface;

FIG. 2D is a side view of the robot of FIG. 2A on the inclined surface;

FIG. 2E is a side view of the robot of FIG. 2A on a vertical surface;

FIG. 3A is a flowchart detailing the assembly of a solid model from basic cuboids;

FIG. 3B is a flowchart detailing the assembly of a solid model from other solid models;

FIG. 3C is a flowchart detailing a surface-expansion algorithm used for expansion of a segment's surface;

FIG. 3D is a flowchart detailing the mapping of volumes bounded by surfaces through axially-aligned cuboids;

FIG. 4A is a perspective view of a model of a storage bin according to one embodiment;

FIG. 4B is a perspective view of a model of a robot according to one embodiment;

FIG. 5 is a perspective view of a model of a multi-level storage facility according to one embodiment;

FIG. 6A is a top view of interconnected volumes according to one embodiment;

FIG. 6B is a perspective view of interconnected volumes according to one embodiment;

FIG. 7A is a flowchart of a method for generating a map including associated functionalities using a model of a facility according to one embodiment;

FIG. 7B is a flowchart detailing the use of maps by a robot for operation within a facility according to one embodiment;

FIG. 8A is a perspective view of an automated storage and retrieval system, according to one embodiment;

FIG. 8B is a perspective view of a portion of the automated storage and retrieval system of FIG. 8A;

FIG. 9 is a perspective view of a portion of an automated storage and retrieval system, according to one embodiment;

FIG. 10 is a perspective view of a portion of an automated storage and retrieval system, according to another embodiment;

FIG. 11 is perspective view of a model of a facility including a grid-like layout according to one embodiment;

FIGS. 12A-12B depict perspective views of a model of a facility with working volumes included in the model according to one embodiment;

FIG. 13 depicts a perspective view of a model of a facility including identified continuous surfaces with associated functionalities.

### DETAILED DESCRIPTION

With the increasing demand for fulfillment services, many entities have started to incorporate automated processes into their fulfillment strategies to increase the efficiency of their services and decrease the amount of human oversight needed. One of the main targets for automation in the fulfillment of goods is at the fulfillment center, where goods are taken in and distributed by human operators. While many companies want to replace human operators with robotic entities for increased efficiency, such an operation is often too expensive and time-consuming to be worth implementing. Thus, the Inventors have recognized issues associated with typical automated storage facilities, including: the costs of the structures and robots, the time needed to setup the automated system, and the level of expertise needed to maintain the automated system. Furthermore, the Inventors have recognized that once installed, typical automated storage systems have a single set configuration where changing the functionality and/or layout of the system may require considerable effort and cost to change. Thus, the Inventors have recognized there is a need for a flexible and cost-efficient Automated Storage and Retrieval System (ASRS) that is able to easily update the functionalities associated with different portions of the ASRS without the need to change the physical structure of the ASRS.

In view of the above, in some embodiments, a storage facility may be represented using a simplified model. For example, objects such as robots, storage containers, and drive surfaces can be modelled using relatively simple geometries such that the model can properly simulate physical clearance and interactions of objects in the real world without being unnecessarily complex. For example, storage containers can be simplified into rectangular prisms and complex robots can be represented as a few geometric shapes. Other objects that may be represented in the three-dimensional model may include workstations, fire protection systems (sprinklers, smoke detectors, etc.), ramps and holes for the robots to travel through levels, and obstructions such as racks, grids, poles, and/or any other appropriate structure that may be present within a storage facility. The usage of simplified models for a warehouse or other environment may significantly reduce the amount of computing power necessary and may allow the ASRS to be far more flexible through easy modification of the models due to the simplicity of the models. For example, a user request to simulate the automation of their storage facility could be completed in hours with a simplified model as compared to the days or weeks it currently takes to physically change and test new configurations in currently available automation systems. In some embodiments, as elaborated on below, surfaces of the storage facility can be mapped using the solid model and defined functionalities associated with the different surfaces.

In some embodiments, a map of a facility including functionalities associated with the different interconnected surfaces one or more robots may operate on may be generated. This may include obtaining a three-dimensional of a storage facility. For example, the model may be generated either locally and/or downloaded from a remotely located database. The three-dimensional model may then be used to determine a plurality of interconnected volumes within the model. These interconnected volumes may then be used to determine a plurality of interconnected surfaces associated with the interconnected volumes within the three-dimensional model. In some embodiments, the interconnected surfaces and volumes may be split into groups with different functionalities. For example, these interconnected surfaces may then be segmented into one or more groups and a functionality may be assigned to each group of the interconnected surfaces. These groups may include different groups associated with different functionalities as well as boundaries between different groups of interconnected surfaces associated with different functionalities. These surfaces may then be used to generate a map with groups of interconnected surfaces associated with their respective functionalities. For example, a group of interconnected surfaces may be defined as a drive surface to define areas for: one or more robots to transit between different locations within a facility; container storage; handling of containers; boundary regions; work stations for human interaction with the system; and/or any other desired functionality. In some embodiments, the generation of a map with functionalities associated with different interconnected surfaces may allow maps to be created easily by filtering the functionalities and/or other appropriate methods.

In some embodiments, a map of one or more groups of interconnected surfaces of a storage facility, and in some instances all of the interconnected surfaces, and their respective functionalities can be used to facilitate operation of one or more robots within an ASRS. For example, a location of a robot inside the storage facility can be determined using any appropriate localization system. This may include localization systems based on Wi-Fi position sensors, radio frequency identification (RFID) location sensors, signal triangulation, dead reckoning, active mapping, and/or any other method of localizing a robot's position within a facility. Once the robot's location is determined, the functionality associated with the surface the robot is located on in the map as well as the map of that surface may be used to at least partially control operation of the robot. Depending on the embodiment, the map may either be uploaded onto the one or more robots and/or it may be generated using the controller of a robot as the disclosure is not so limited.

The disclosed methods and systems may permit efficient and flexible use of robots located in such a system that offers benefits in a variety of situations. For example, if a user requests an amount of a first item from a first storage location and an amount of a second item from a second storage location, a system can order a first robot to a first storage location while a second robot can be ordered to a second storage location. The amount of the first item may be too much for a single robot to carry, so at least one more robot may be deployed to retrieve the requested amount of the first item. The system can coordinate all the robots with a map of the interconnected surfaces and their respective functionalities, such that the robots can be pathed in such a way that they do not interfere with each other. Furthermore, a map of all the interconnected surfaces and their respective functionalities can allow the distribution of items and robots according to the frequency of request of each item. For example, a storage space hard to reach through the drivable spaces may be allotted less frequently requested items. A storage space easy to reach through the drivable paths may be given items that are more frequently requested. Such a system may also make it possible to easily change these assigned functionalities to permit cheap fast reconfiguration of the ASRS depending on the needs of a user.

In view of the above, the Inventors have recognized and appreciated that there may be certain benefits associated with a modular ASRS with simplified, flexible, and robust models. For example, a modular ASRS system has the flexibility to adapt to modifications as needed. Furthermore, a modular ASRS system may be more cost-effective due to the minimal labor associated with any modifications and the reusability of the grid setup.

In certain embodiments, a modular ASRS may use one or more identical robots. For example, the robots may be identical and may include multiple robots configured to perform either the same and/or different tasks. However, the use of different robots associated with different functions and tasks are also contemplated.

In one embodiment, the modular ASRS may use magnetically-adhesive robots such as the robots disclosed in U.S. Pat. No. 11,110,593. The ramps, ceilings, walls, floors, levels, and/or any other desirable surface in an ASRS may be made of magnetic material and the magnetically-adhesive robots may be capable of magnetically attaching to and travelling horizontally and vertically across these surfaces. In another embodiment, the modular ASRS may use any robot attachable to a pulley. The ramps and levels may contain a series of pulleys to assist the robot in travelling horizontally and vertically. The robots may be capable of carrying payloads of differing weights while attached to the ramps and levels through a series of pulleys. In a further embodiment, the ramps and levels of the modular ASRS may have tracks to aid robots in travelling both horizontally and vertically. The robots may be able to be attached to the tracks. The robots may be capable of carrying payloads of differing weights while attached toe the ramps and levels through tracks. In view of the above, it should be understood that the currently disclosed systems and methods are not limited to being implemented with any particular type of robot, and the current disclosure may be applied to any type of ASRS with any type of robot as the disclosure is not limited in this fashion.

In some embodiments, a robot may include a retainer constructed and arranged to hold a payload on the robot. For example, the retainer may include one or more features to secure the payload to the robot such that the payload is held to the robot when the robot moves along surfaces with varying orientations (e.g., along downwardly-facing surfaces from which the robot is suspended). However, it should be understood that other retainer configurations may be suitable in some applications. For instance, a retainer may include a platform on which a payload can be placed or a receptacle that receives a payload, and frictional forces may be sufficient to hold the payload in the retainer. In some embodiments, a robot may further include a gripper configured to retrieve the payload from a storage location. For example, the gripper may be movable relative to the retainer to move the payload from the storage location to the retainer. Moreover, in some instances, a gripper may form a part of the retainer. For example, the gripper may secure the payload to the retainer to hold the payload in place after retrieving the payload from the storage location. After receiving a payload in a retainer, a robot may move along a surface to transport the payload to a delivery location, and subsequently, the payload may be removed from the retainer. For instance, a robot including a gripper may use the gripper to offload the payload from the robot.

In addition to the above, a robot in any of the embodiments disclosed herein may include a controller including one or more processors configured to control one or more aspects of the operation of the robot. For example, the controller may be coupled to load sensors and adhesion magnets of the robot, and the controller may be configured to adjust the attractive magnetic force of the adhesion magnets based on the forces measured by the load sensors. Alternatively or additionally, the controller may be coupled to a drive system to control movement of the robot along a surface. Moreover, in some embodiments, a robot may include one or more sensors to detect a location of the robot along the surface, and the controller may control the drive system to propel the robot along the surface based on location data measured by the location sensor. In embodiments including a gripper, the controller may further be coupled to the gripper to control loading and unloading of payloads. Depending on the particular embodiment, a controller may be mounted on the robot, and/or a robot may communicate with a centralized control system separate from the robot. In some applications, multiple controllers may be used to control different aspects of the operation of a robot. For example, a robot may include one or more controllers located on the robot to control the adhesion magnets and drive system, while a remote, centralized control system may control aspects related to the location of the robot and transporting payloads to different locations. However, it should be understood that the current disclosure is not limited to any particular configuration of controllers.

According to some aspects, the robots described herein may be implemented as part of an automated storage and retrieval system (ASRS), in which a plurality of objects are stored within a storage structure such as a rack system. In some embodiments, the storage structure may include surfaces on which one or more robots can move to transport objects within the storage system. For example, the storage system may include magnetic surfaces to which the above-described robots can adhere while transporting payloads including one or more objects throughout the storage system. The inventors have recognized and appreciated that such arrangements for an ASRS may provide numerous advantages compared to conventional ASRS systems. For example, because the robots may be able to move along any suitable surfaces of the storage structure, an ASRS according to the present disclosure may not require any complex rail or guide structures which are often used in conventional systems. In this manner, the systems described herein may allow for simpler installations, lower costs, and/or improved modularity compared to conventional systems.

In some embodiments, an ASRS may correspond to a facility including a storage structure comprising multiple levels of storage, and each level may be connected by one or more ramps or walls. With such arrangements, one or more robots as described herein may be movable throughout the storage structure, including between levels by moving along the walls and/or ramps. Moreover, the robots may travel along downwardly-facing surfaces that form the ceilings of each level in the storage structure. In this manner, a robot may move along a ceiling to a location above a payload, and the robot may retrieve the payload, for example, via a gripper that is extendable below the robot to the underlying surface on which the payload is stored. The robot may subsequently transport the payload to a delivery location where the payload is unloaded from the robot. In some instances, the delivery location may be a different location within the storage structure. In other cases, the delivery location may correspond to a location of another robot, such that the payload may be transferred between different robots moving within the storage system.

In some implementations, a plurality of robots in an ASRS may be configured with traffic rules to improve capacity or productivity of the system as a whole. For example, as noted above, the robots may communicate with a centralized controller which may control the individual robots by sending reconciled commands to each robot. Accordingly, in some embodiments, each robot may not be required to have information about any of the other robots in the system (such as their number, tasks, or behavior). However, other implementations may use a less centralized approach in which individual robots receive higher level instructions regarding one or more tasks, such as instructions relating to transporting a payload within the storage structure. In some embodiments, the fleet of robots may run identical software.

In some embodiments, the operations within the ASRS may be managed by a central control system that provides a teamwork or swarm-like collaboration of the robots. For example, the central control system may determine an appropriate sequence of operations for the robots, coordinate storage locations of objects or items to be picked up or to be delivered within a storage structure, and/or provide traffic control and itinerary planning for the robots. The central control system may optimize movement of the robots such as by attempting to minimize the travel distance of each robot between the storage locations, and/or by balancing the location of objects in the system based on an expected frequency of access, (e.g., less popular objects may be placed in the farthest locations requiring the largest travel distances).

Depending on the particular embodiment, the surfaces on which the robots described herein may adhere via one or more adhesion magnets may include any suitable magnetic surface, such as a surface comprising a ferromagnetic material. For example, a surface may include a ferrous material such as iron or an iron alloy (e.g., a steel alloy). In other embodiments, surfaces comprising an arrangement of permanent magnets and/or electromagnets that can interact magnetically with one or more adhesion magnets on the robots may be suitable. Moreover, in some embodiments, a surface may comprise paramagnetic material, a ferromagnetic material, or any other suitable magnetic material that can interact with the adhesion magnets to provide a sufficient attractive magnetic force. Additionally, combinations of the above described materials and/or arrangements may be suitable. Accordingly, it should be understood that the current disclosure is not limited to any particular type of magnetic surface on which the robots move. In addition to the above, it should be understood that in some instances, the robots may move along a non-magnetic surface. For example, the robots may travel along horizontal surfaces and/or inclined surfaces on which frictional forces are sufficient to maintain contact between the robot and the surface while also permitting movement of the robot along the surface.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

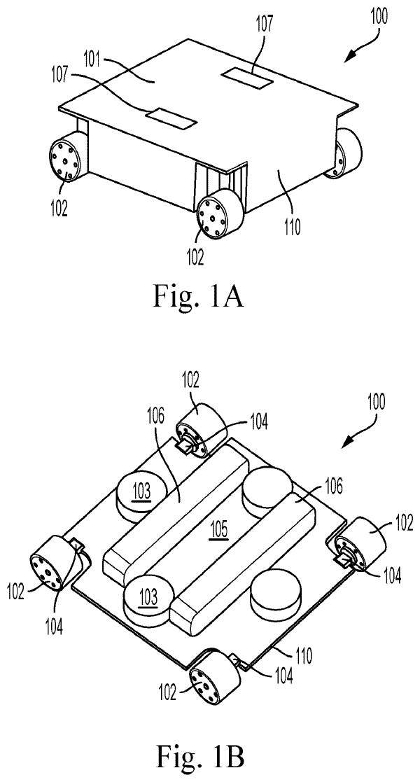

FIGS. 1A-1B depict one embodiment of a robot 100 according to some aspects of the current disclosure. The robot 100 includes a chassis 110 on which a locomotion system is mounted to permit movement of the robot along a surface. In the depicted embodiment, the locomotion system includes four wheels 102 positioned around the chassis 110, though it should be understood that other features capable of permitting movement of the robot along the surface (e.g., treads, rails, legs, and so on) also may be suitable. While at least four wheels may be used in some embodiments, other numbers of wheels may be used, for example at least one wheel, at least two wheels, at least three wheels, at least five wheels, or any suitable number of wheels.

As shown in FIG. 1A, the robot includes a retainer 101 configured to hold a payload (not depicted) such that the robot may transport a payload (e.g., within an ASRS or other suitable system). In the depicted embodiment, the retainer 101 is formed as a platform on which the payload can be placed, however, other arraignments may be suitable, such as a retainer configured as a receptacle. Moreover, retaining elements 107 may be included on the retainer to secure the payload to the retainer. For example, the retaining elements may include one or more grippers, clips, latches, adhesive surfaces, fasteners (e.g., temporary fasteners such as hook-and-loop type fasteners), or any other retaining structure capable of securing a payload to the retainer. While two retaining elements 107 are depicted in FIG. 1A, it should be appreciated that any suitable number and/or arrangement of retaining elements may be used, as the current disclosure is not limited in this regard.

FIG. 1B depicts the interior of the robot 100 of FIG. 1A. As illustrated, the robot includes adhesion magnets 103 distributed around the chassis 110; as discussed above and as described in more detail below, the adhesion magnets 103 are configured to generate an attractive magnetic force between the robot and the surface on which the robot moves to maintain contact between the robot and the surface.

Additionally, the robot includes load sensors 104 coupled to each wheel 102 of the locomotion system. In this embodiment, the load sensors are mounted on respective axles connecting each wheel 102 to the chassis 110, such that the load sensors are configured to measure a net force between each wheel 102 and the surface. The load sensors 104 and adhesion magnets 103 are operatively coupled to a controller 105 that is configured to adjust the attractive magnetic force from each adhesion magnet in response to changes in the forces measured by the load sensors 104. Moreover, the robot includes one or more power supply units such as batteries 106 to provide power to the various systems of the robot, such as to adjust the attractive magnetic force provided by the adhesion magnets 103.

While the embodiment depicted in FIGS. 1A-1B includes four adhesion magnets 103 distributed around the chassis 110, it should be understood that other arrangements may be suitable. For example, other embodiments may use two adhesion magnets located on opposing sides of the chassis, a single adhesion magnet positioned in a central location on the chassis (e.g., near the geometric center of the chassis or near the center of mass of the robot), or the robot may use more than four adhesion magnets arranged in any suitable configuration.

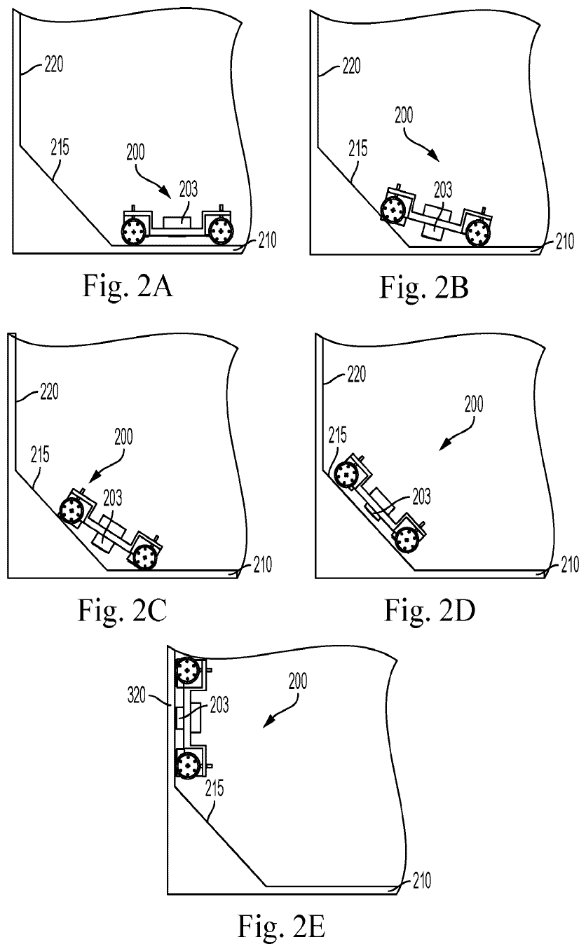

Referring now to FIGS. 2A-2E, operation of one embodiment of a robot 200 is described in more detail. In particular, FIGS. 2A-2E depict a robot moving from a horizontal surface 210 onto a vertical surface 220 via a ramp 215. The robot 200 includes one or more adhesion magnets 203 that are movable toward or away from the surfaces to adjust the attractive magnetic force between the robot and the surfaces. For example, as shown in FIG. 2A, the adhesion magnet may be retracted when the robot 200 is moving along the horizontal surface, and as the robot moves onto the ramp 215, the adhesion magnet may move toward an extended position to accommodate an increased distance between the robot and the surface resulting from the transition from the horizontal surface 210 to the ramp 215, as illustrated in FIGS. 2B-2C. Once the robot 200 is on the ramp 215 (FIG. 2D), the adhesion magnet may retract to an intermediate position to generate an attractive magnetic force sufficient to maintain the robot in contact with the ramp 215 while also permitting movement of the robot. Finally, when the robot moves onto the vertical surface 220, the adhesion magnet may move to an extended position to increase the attractive magnetic force and maintain the robot in contact with the surface. Of course, while a particular type of robot is depicted as operating on these interconnected surfaces, other types of robots capable of being magnetically attracted to vertical walls and ceilings may also be used. Also, as noted previously non-magnetic robots may also be used as the disclosure is not so limited.

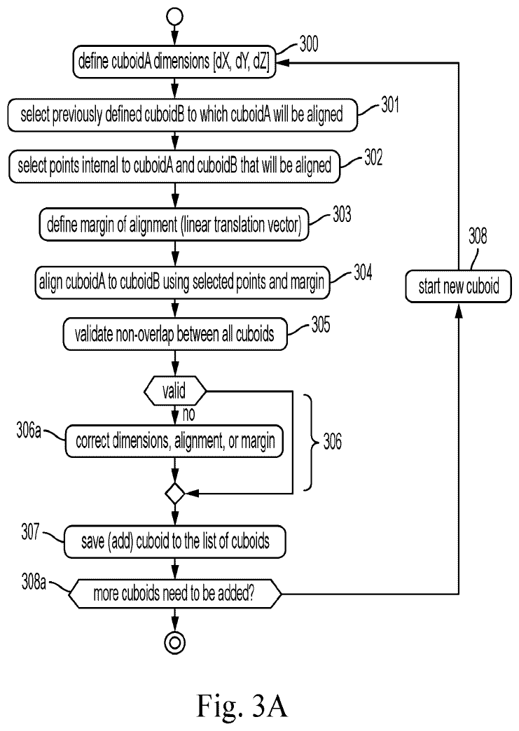

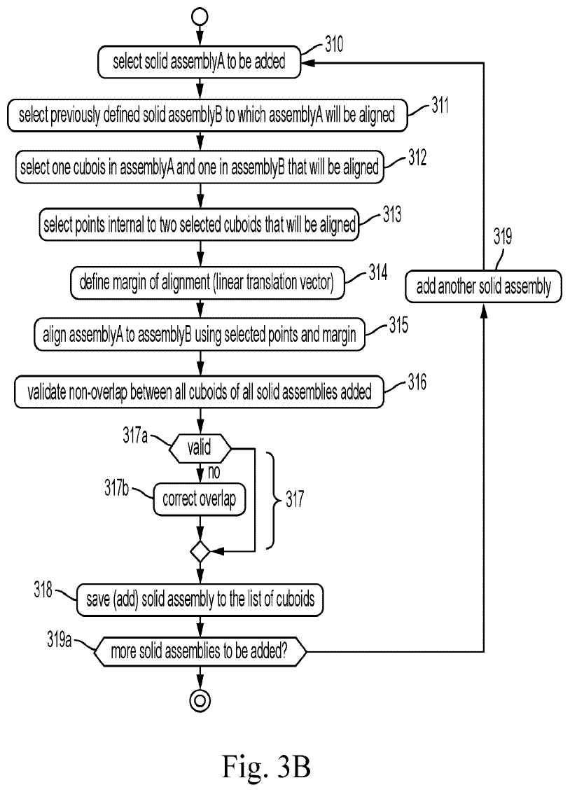

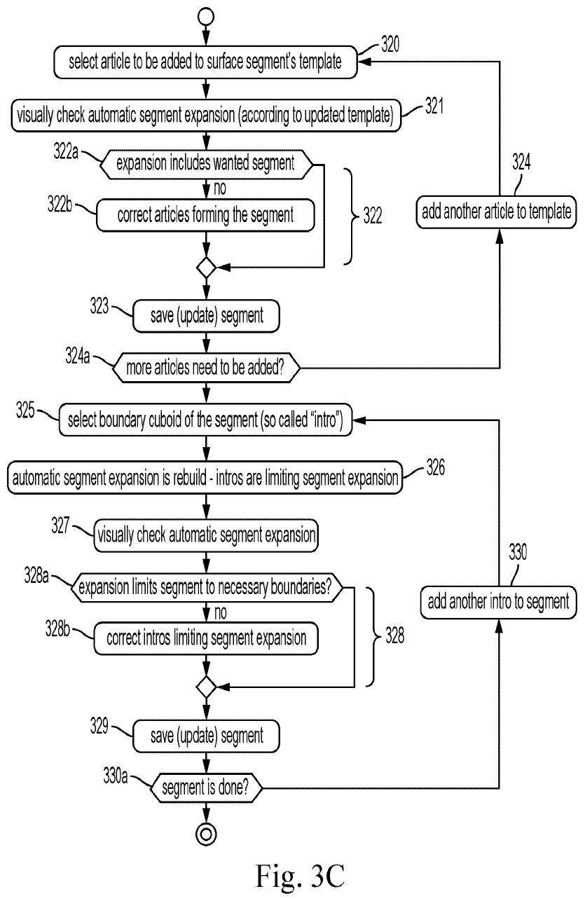

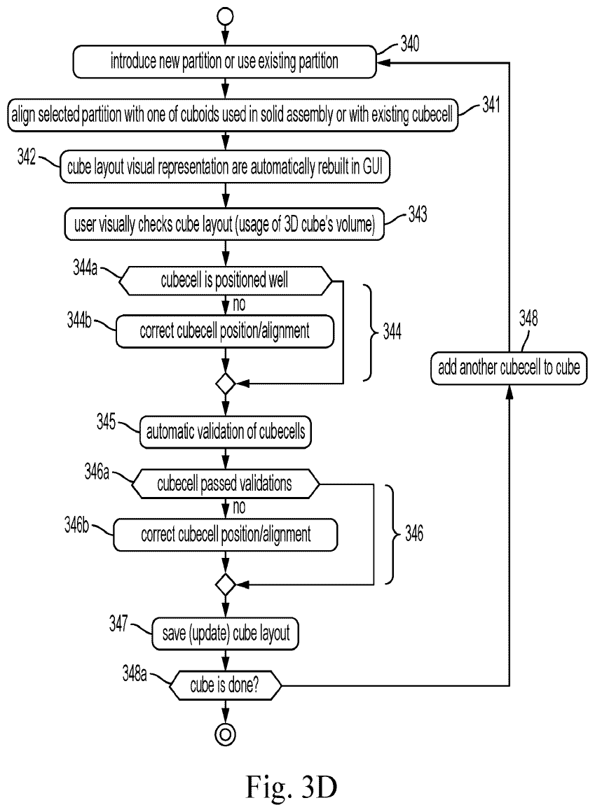

FIG. 3A-3D depict one embodiment of a series of flowcharts detailing procedures and methods associated with generating a model of a modular storage facility layout which may be implemented as appropriate processor executable modules configured to perform the indicated processes.

As elaborated on further below, in some embodiments, a solid assembly designer may be configured to allow users to model and represent solid bodies as a set of non-intersecting axially-aligned cuboids. For example, a model may use cuboids for modeling any three-dimensional component present within a storage facility. Depending on the complexity of the feature being modeled, either a single cuboid or multiple cuboids may be used to model the feature. These cuboids may then be assembled as an overall solid model corresponding to a desired storage facility. In some embodiments, the solid model may be composed of numerous cuboids and/or sets of cuboids that are aligned at selected points and/or along selected axes to model the various objects in a storage facility including, the storage facility layout, containers, robots, workstations, and/or any other object, surface, or other feature that may be present within the storage facility.

The resulting storage facility model may be further used for modeling, simulation, and real-world execution of container handling and robot movement within a storage facility. In some embodiments, a grid layout of a storage facility may be a simplified three-dimensional model of a grid for a storage facility. For example, a grid can be the barebones structure of a storage facility, comprising of levels, ramps, supports, walls, and/or other appropriate structures. A grid can also include other structures to model the freedom of movement of the robots, such as fire extinguishers, workstations, fire hazard detectors, doors, and/or any other appropriate structure that may be present within a storage facility.

This simple model may allow high-performance construction, automated testing, and rendering of representations of a storage facility including hundreds, thousands, or any other desired number of cuboids depending on the size of a storage facility to be modeled. In some embodiments, rendering of such solid assemblies can be done in a web browser in real-time on conventional computers, though the use of stand-alone computers for modeling, rendering, and mapping of such models is also contemplated. In some embodiments, the initial modeling of a basic grid may be performed by users using two workflows: assembling solid models from basic cuboids (workflow on FIG. 3A), and assembling solid models from other solid models (workflow on FIG. 3B). Once solid assemblies are created and saved into a database, they can be reviewed, shared, duplicated by the users on a multi-tenant web-based system, and/or used in any other desired manner.

FIG. 3A depicts one embodiment of a workflow of the assembly of a solid model from basic cuboids to model a desired structure within a storage facility including, for example, a repeated physical structure that may be used to form a grid layout of the storage facility (e.g., a portion of a level with corresponding supports, or other feature), a wall, a ramp, a robot, a container, fire extinguishers, workstations, fire hazard detectors, doors, and/or any other appropriate structure. When modeling a structure, a user may determine a new cuboid of set dimensions at 300. In instances where a previously defined cuboid is already present, the new cuboid may be aligned to a previously-defined cuboid at 301. A set of points on the newly-defined cuboid and the previously-defined cuboid can be defined at 302, such the two cuboids can be aligned together at the defined points. A margin of alignment for the axially alignment of the two cuboids can be defined at 303. With the defined sets of points and margin of alignment for the two cuboids, the newly-defined and previously-defined cuboids can be aligned together at step 304. The solid assembly designer may detect if the alignment of two cuboids is appropriate by checking if any overlapping volumes are present between the existing cuboids 305. In some embodiments, the solid assembly designer may detect overlapping volumes automatically. Depending on the validity of the overlapping volume check 305, the solid assembly designer may force the model to go through loop 306 until no volume overlaps exist. Loop 306 can correct either the dimensions, points of alignment, or margin of alignment of any illegal overlapping cuboids at 306a; in some embodiments, the method of correction may be to prompt the user by highlighting any areas of illegal overlaps and asking for manual input. In other embodiments, the method of correction may be automatic where the module may shift the two cuboids until there is no overlap to provide a orientation and position of the cuboids that is closest to the commanded orientation and position while avoiding overlap between the cuboids. Once there are no overlapping cuboids, the newly-defined position and orientation of the cuboid can be saved into the assembly of existing cuboids at 307 and the solid assembly designer may prompt the user on whether to define another cuboid at 308a. If the user chooses to define more cuboids to add onto the solid model, then condition 308a is true, and the solid assembly designer may enter loop 308 to start a new cuboid. Steps 300-307 can be repeated until the initial model generation is finished and prompts condition 308a to be false.

FIG. 3B is a flowchart detailing one embodiment for the assembly of a solid model from other solid models including one or more cuboid subassemblies. Specifically, instead of adding one cuboid at a time as in FIG. 3A, a user may choose to combine multiple solid models together in the solid assembly designer. The user may choose two solid models 310-311. In some embodiments, one solid model can be newly-defined by a user, and another solid model can be preexisting in the current assembly. One cuboid from each solid model assembly 312 can be selected as a junction between the solid models for alignment purposes. This alignment may include defining selected points on each cuboid to align the two solid models at step 313 and defining a margin of alignment for the two solid models at step 314. The two cuboids can then be aligned according to the selected points on each cuboid and a margin of alignment at 315. A validation process, which may be automatic in some embodiments, can then be used to check if any overlap exists between any cuboids of the two solid models. If points of overlap exist, the condition 317a is not valid, and the system can iterate through loop 317, which can correct every point of overlap at 317b until there are no points of overlap remaining. The correction process 317b may be either manual or automatic. In an automatic correction process, the two solid models may be shifted until there is no overlap, and then realigned together at the closest aligned and non-overlapping point between the two models. Once step 316 detects no overlaps between the cuboids of both solid models, condition 317a can prevent further iteration of loop 317 and the overall model of the storage facility including the assembled subassemblies can be saved to non-transitory computer readable memory as a list of cuboids or other data structure at step 318. The user may choose to add more solid assemblies 319a, and the flowchart returns to step 310 to iterate steps 310-318. This process may be continued until all of the desired structures within a storage facility have been modeled.

Each of the two workflows in FIG. 3A-3B may include other functionalities, including other types of validations for added cuboids. For example, one possible validation may be that no volume is floating in the air when the solid assembly is completed and when a user attempts to save updates to the model. In such an embodiment, the plane Z=0 can be used as a ground level for the purpose of this validation.

After a model of a facility including the above disclosed simplified cuboid grid has been built, surfaces in the grid can be segmented and associated with different functionalities corresponding to the functions these surfaces may be used for during operation of the modeled storage facility. One possible embodiment of such an algorithm is elaborated on further below.

FIG. 3C is a flowchart detailing one embodiment of a surface-expansion module that may be used for expansion of a segment's surface. The surface-expansion algorithm for segmentation can be broken down into two main portions: adding surfaces to a surface segment 320-324, and limiting expansion of the defined surface segment(s) 325-330 using boundaries disposed between adjacent portions of an interconnected surface. During the first portion 320-324, a user may define a new portion of an interconnected surface of the model for adding to a desired surface segment at 320. In some embodiments, the new portion of the surface may not be interconnected with a previously selected surface segment, and thus the selected portion of the surface may automatically expand to the previously selected surface segment to form a combined segment of the interconnected surface. For example, the algorithm may expand the first selected surface of a first cuboid towards a second selected surface of a second cuboid such that the surfaces extending between the two selected surfaces may be included in the defined surface segment. In other embodiments, the new portion of the surface may be directly adjacent to the existing surface segment, such that the new portion of the surface may be directly added to the existing segment. At step 321, the combined surface segment may be examined either visually by a user and/or automatically to confirm the desired surface segments are continuous with one another. This inspection may confirm that the new portion of the surface segment was properly added to the desired surface segment at 322a, and if not, the surfaces forming the segment can be edited at 322b. If the segment is correct in 322a, then the correction step 322b can be skipped and the defined surface segment can be saved in the model on non-transitory computer readable memory at 323. If the user decides that more surfaces need to be added to the segment 324a, then loop 324 can proceed and recursively edit the segment until all desired surfaces are incorporated into the segment.

When a surface segment has been defined as desired by the user through steps 320-324, one or more boundaries associated with one or more of the defined surface segments and automated expansion of the one or more surface segments may be implemented according to steps 325-330. The user may select one or more boundary cuboids to bound a surface segment in a manner similar to steps 320-324. An expansion module may then automatically expand the previously-defined surface segment to include adjacent interconnected surfaces next to the surfaces included in a surface segment until a boundary cuboid and/or non-continuous portion of the model (e.g., an edge, gap, or other non-continuous surface feature) is encountered at 326. An inspection, such as a visual inspection, may be performed to confirm that the segment has expanded as desired at 327, such that the one or more boundary cuboids are limiting the expansion of the surface segment to the desired portion of the model. This check of the expanded segment may also include an automated check to determine if the expanded surface segment overlaps with a separate adjacent surface segment. If the segment is correctly limited by the boundary cuboids at 328a, the correction step 328b may be skipped and the expanded surface segment in the storage facility model may be saved on computer readable non-transitory memory at 329. Otherwise, if the condition 328a is false (e.g., the expansion overlapped with separate adjacent surface segments, expanded to an undesired area, or other undesired condition occurs), the boundary cuboids limiting the surface segment expansion may be modified either manually or automatically at 328b. This adjustment process may continue until the surface identification and expansion process may be indicated by the user as being complete at condition 330a. The loop 330 may cause steps 325-330 to continue recursively to add any number of different portions of an interconnected surface to a defined surface segment.

The above processes shown in steps 320-330 may be used to define and expand any number of separate surface segments within a model of a storage facility (e.g., ramps, walls, floor segments, ceiling segments, and/or any other desired type of segment). As detailed further below, the model may also be updated to include functionalities associated with the different surface segments. For example, the surface segments may be assigned different functionalities such as drivable space; container storage; container handling regions; boundary regions; workstations for human interaction with the system; and/or any other desired functionality. The surface segments may also be defined to include properties related to the different surface segments including, for example, a surface material (e.g., magnetic, non-magnetic, wood, metal, plastic, and/or any other appropriate type of property).

Once storage surfaces for bin storage, drive surfaces for robot movement, and/or any other desired surface segment with a corresponding functionality has been defined in the embodiment of FIG. 3C for a given grid, the usable internal volume of the model can be defined using a method such as that illustrated in the embodiment of FIG. 3D, which is a flowchart detailing the mapping of volumes bounded by surfaces through axially-aligned cuboids. The bounded volumes can be expressed through a data structure referred to herein as a partition. In some embodiments, a partition may correspond to a cuboid-shaped volume of useable void space (i.e., unobstructed space) within a sub-portion of the model. When a partition (i.e., defined void space) is inserted into the model and aligned with other partitions these volumes it may be referred to as a cubecell herein. For example, in some embodiments, a user may create a new partition or use an existing partition with a predefined geometry at 340. In one such embodiment, a user may manually input an expansion distance and direction for generating a desired partition where the partition may be extended in the input direction by the corresponding input distance. In either case, once defined, the desired partition may be positioned and aligned with an existing cuboid, or other appropriate portion, of the model at 341. A visual representation of a cube layout may be shown in a graphical user interface (GUI) on any appropriate display, where the user can visually inspect the cube layout at 343. This optional visual inspection may confirm adjacent partitions are aligned and non-overlapping with other partitions and/or solid portions of the model at step 344a. If there are misalignments and/or overlaps, the one or more portions can be edited at 344b to reposition and/or re-align the one or more partitions to eliminate the undesired misalignments and/or overlaps. If the cube layout is correct at 344a, the correction step 344b can be skipped and the method can move onto an automatic validation of cubecells using a validation module at 345 where overlaps and/or misalignments of the partitions forming the one or more cubecells of the model may be identified. If the cubecell passes the automatic validation step 346a, then the updated model including the cube layout can be saved to a non-transitory computer readable memory at 347. Otherwise, the cubecell position and alignment may be adjusted in step 346b to eliminate the overlaps and/or misalignments. The partitioning process can end at 348a if the cube layout is complete; otherwise, another cubecell can be added at step 348 and the steps 340-348 may be repeated until the desired partitioning of the void space within the model is complete.

The above methods of FIGS. 3A-3D related to generating a model may be implemented by at least one processor associated with either a local and/or remotely located computer and/or server. The disclosed methods may be embodied as computer readable instructions stored on non-transitory computer readable memory associated with the at least one processor such that when executed by the at least one processor the system may perform any of the actions related to the methods disclosed herein. Additionally, it should be understood that the disclosed order of the steps is exemplary and that the disclosed steps may be performed in a different order, simultaneously, and/or may include one or more additional intermediate steps not shown as the disclosure is not so limited.

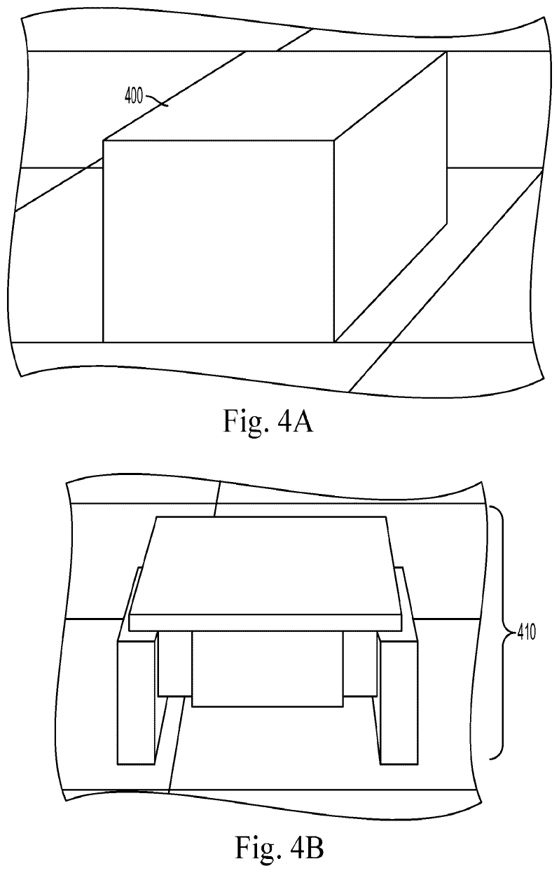

FIG. 4A depicts one embodiment of a possible model of a storage bin. The storage bin 400 can be simplified to a rectangular prism for the purposes of modeling and simulated use within an automated storage space. One aspect of the model can be proper clearance for when the robots interact with the facility, and having a simple model for storage containers can be beneficial by decreasing the amount of computation necessary. A mid-sized storage facility may contain thousands of storage bins, such that the amount of computation saved by simplifying storage bins increases significantly as the storage facility scales.

FIG. 4B depicts one embodiment of a possible model of the robot. FIG. 4B is a simplified model of the robot 410 shown in FIG. 1A and FIG. 1B. The robot may be significantly more complicated in reality, but simplifying the model can allow significant computational power to be saved while still maintaining the proper information to simulate the clearance space of the robot.

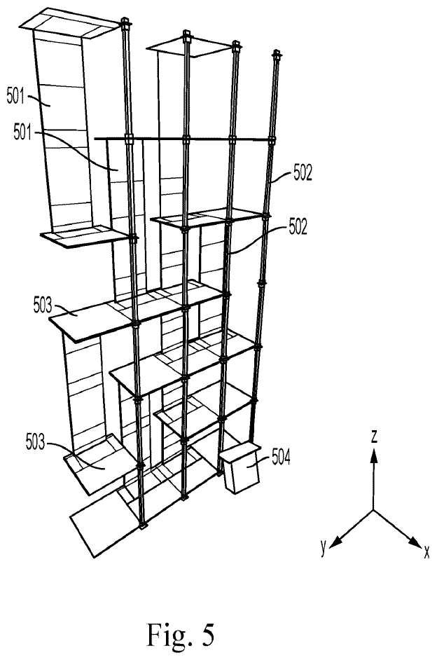

FIG. 5 is a drawing of a multi-level storage facility. The multi-level storage facility is restricted to only one block in the x-axis to highlight the transitions between vertical levels. Robots travel through the grid on drive surfaces of the separate levels 503 which may include both upward and/or downwardly oriented surfaces relative to a direction of gravity (i.e., ceilings and floors), and traverse different levels of the facility by attaching to and climbing ramps extending between the vertically oriented surfaces on the different levels and walls 501 extending between the levels as shown by the corresponding structures in the model. The supports 502 may be included in the simplified model as they may interfere with the robots as they drive through the facility represented by the model. Workstations 504 may also be part of the model of a storage facility.

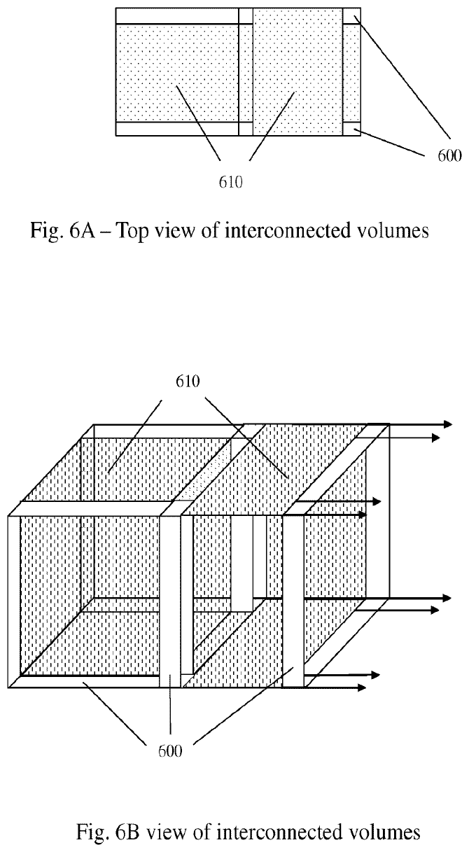

FIGS. 6A and 6B depict one embodiment of interconnected volumes within a model. Functional space 610 can be used for various purposes including but not limited to driving and storage. Non-functional space 600 cannot be used, and may include objects such as racks/grids, fire safety measures, poles, or other obstructions that may be included in the model, as they may impact proper robot clearance. The top view of interconnected volumes can show that functional spaces share at least one edge or boundary.

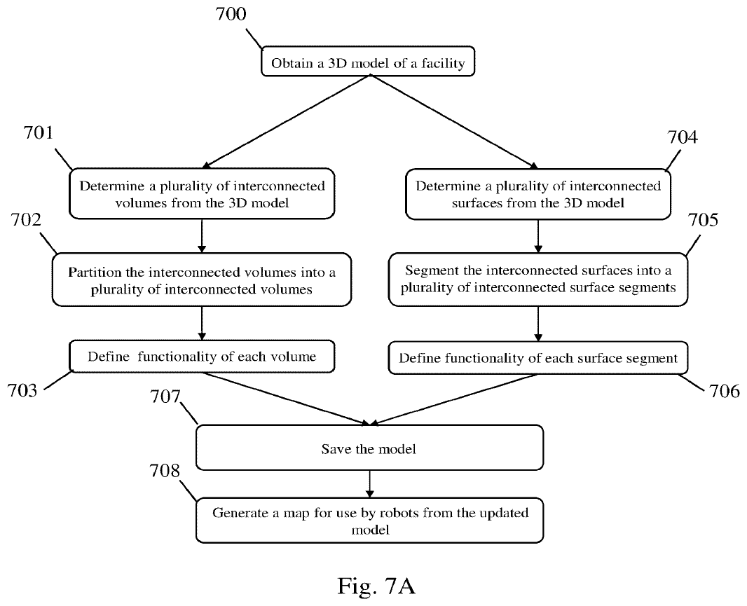

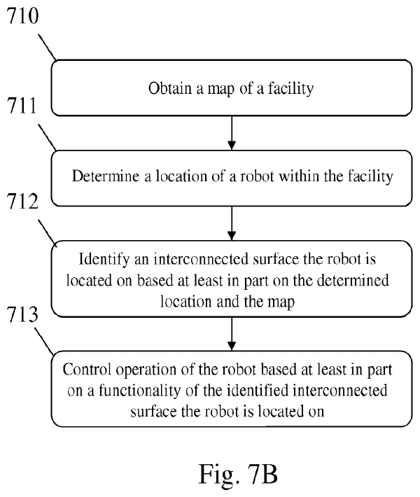

FIG. 7A is a flowchart detailing one embodiment of a procedure for obtaining a map for use by one or more robots from a three dimensional model including information related to the layout and functionality of one or more portions of a storage facility for use with an ASRS. A simplified three dimensional model of the storage facility may be obtained at 700 by either generating a model, recalling a model from memory, downloading a model from a remotely located database, and/or any other appropriate method. In some embodiments, a plurality of interconnected volumes can be determined at 701 from the model and a plurality of interconnected surfaces can be determined at 704 from the model. Interconnected volumes may result from the workflow seen in FIG. 3D, in some embodiments, and may be defined such that one or more boundaries can be disposed between adjacent portions of an interconnected volume. Thus, the interconnected volumes can be partitioned into a plurality of interconnected volumes at 702. In some embodiments, the model may be partitioned based on the desired functionality for each of the separate partitioned volumes. For example, a user may select a first set of interconnected volumes to form a first partitioned volume that is meant to function as a container storage space within the model. Thus, after the interconnected volumes are partitioned into a plurality of separate portioned volumes, the model may be updated to include a functionality defined for each of the one or more the partitioned volumes in step 703. In some such embodiments, each one of the plurality of interconnected volumes can be assigned a functionality such as drivable space; container storage; container handling; boundary regions; work stations for human interaction with the system; and/or any other desired functionality.

Similar to the partitioned volumes of the model, the one or more interconnected surfaces of the model may be segmented into a plurality of interconnected surface segments at 704. In some embodiments, the interconnected surfaces may be segmented as seen in workflow FIG. 3C such that one or more boundaries may be disposed between adjacent segmented surfaces of the one or more interconnected surfaces. The segmented surfaces can be then functionalized at 705, where each segment of interconnected volumes can be assigned a desired functionality such as drivable space; container storage; container handling; boundary regions; work stations for human interaction with the system; and/or any other desired functionality. This may also include defining one or more properties related to the surface including, for example, a material property of the surface as noted above. The updated model can be optionally saved to non-transitory computer readable memory at step 707, and a map can be generated for use by robots with the updated model at 708. A map can be updated whenever a new volume is added to the model, and a final map for use can be saved after step 707. A map can be generated from the overlapping boundaries of coplanar faces of two interconnected volumes which contact a drivable surface. The overlapping boundaries from all qualified interconnected volumes in the storage facility can be represented as a two-dimensional diagram. When overlapping boundaries intersect, respective faces of touching volumes can be designated as nodes. The center of each node can be found, and a line can be drawn from the center of each node to an adjacent node. If a robot has enough clearance to move and rotate along the drawn lines between the centers of nodes, the drawn lines can be categorized as drive paths and added to a map. The map can either be generated using a controller with one or more processors located on a robot or the map may be generated on a remotely located server, central controller, or other system for subsequent upload to the one or more robots. The generated map can either be stored on a robot or on a remotely located server on appropriate non-transitory computer readable memory for future recall. If the map is stored on a remotely located server, then the robot may access the remotely located server during a preloading process to acquire the map.

FIG. 7B is a flowchart detailing the general use of the generated maps by one or more robots. In order to control robot movement within the storage facility, a map including information related to a plurality of interconnected surfaces located in the storage facility can be obtained at 710. The map can include information about the assigned functionalities of the plurality of interconnected surfaces. The location of a robot within the storage facility can also be determined at 711 using any appropriate localization system and/or method. The interconnected surface the robot is located on can be determined based at least in part on the determined robot location within the facility and then correlated with a corresponding location within the map of the storage facility at 712. Control operations of the robot can be performed, based at least in part on the determined robot location and a functionality of the identified surface segment and/or partitioned volume the robot is located on and/or in at 713 using an onboard controller, including one or more processors, of the robot.

The above methods in FIGS. 7A and 7B may be implemented by one or more controllers including at least one processor of a robot, centrally located controller, remotely located server, or other appropriate system as disclosed herein. The methods may be embodied as computer readable instructions stored on non-transitory computer readable memory associated with the at least one processor such that when executed by the at least one processor the robots and/or systems may perform any of the actions related to the methods disclosed herein. Additionally, it should be understood that the disclosed order of the steps is exemplary and that the disclosed steps may be performed in a different order, simultaneously, and/or may include one or more additional intermediate steps not shown as the disclosure is not so limited.

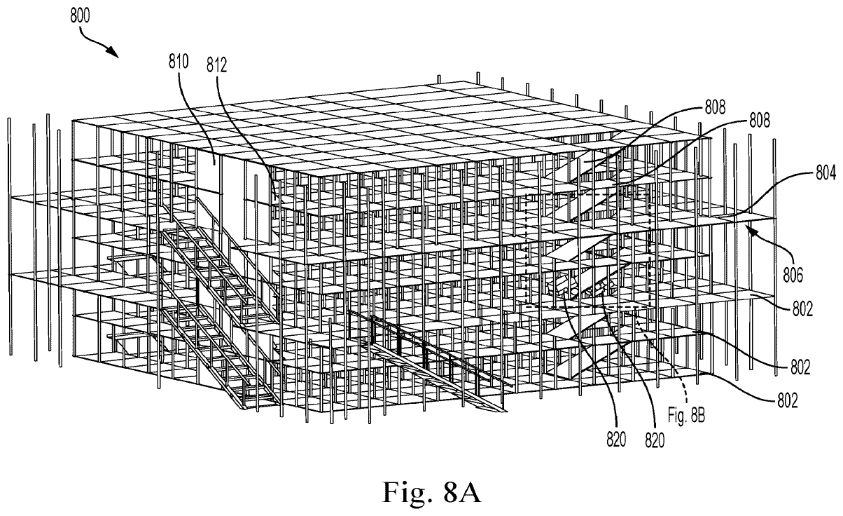

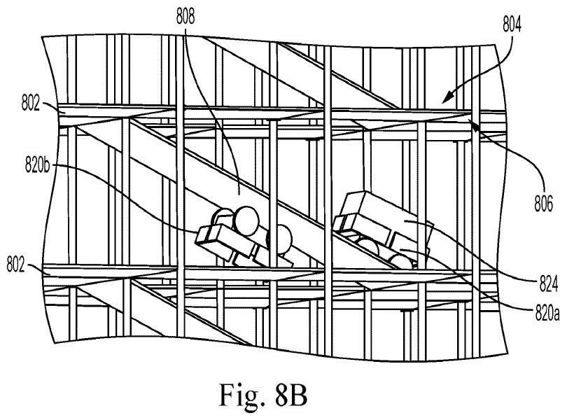

Referring now to FIGS. 8A-10, various aspects of an exemplary ASRS utilizing one or more of the robots described herein are described in more detail. FIG. 8A depicts an ASRS 800 including a storage structure having a plurality of levels 802. A plurality of objects (not depicted) may be stored at storage locations on the various levels 802 of the storage structure. Each level includes a floor 804 and a ceiling 806; for example an underside of a floor of one level may define a ceiling of the underlying level. The storage structure includes a plurality of ramps 808 that connect the floors/ceilings of adjacent levels. Additionally, the storage structure may include one or more vertical walls 810 connecting one or more levels, and wall connecting ramps 812 may connect the floors/ceilings of the levels 802 to the walls 810. One or more robots 820 may be movable along the floors 804, ceilings 806, ramps 808, walls 810 and/or wall connecting ramps 812 to transport objects throughout the storage system. In particular, at least the ceilings 806, ramps 808, walls 810 and/or wall connecting ramps 812 may comprise a magnetic material such that the robots 820 may adhere to the various surfaces via an attractive magnetic force as discussed above. In some embodiments, the levels 802 also may include a magnetic material.

FIG. 8B depicts a portion of the ASRS 800 shown in FIG. 8A including two robots 820 traveling along ramps 808 between levels of the storage structure. In particular, a first robot 820a is traveling between floors 804 of adjacent levels along a partially upwardly facing surface of a ramp 808, and that robot is transporting a payload 824. A second robot 820b is traveling between ceilings 806 of the adjacent levels, and that robot is traveling along a partially downwardly facing surface of the ramp. The robot 820b maintains contact with the ramp via an attractive magnetic force between one or more adhesion magnets on the robot and the surface of the ramp.

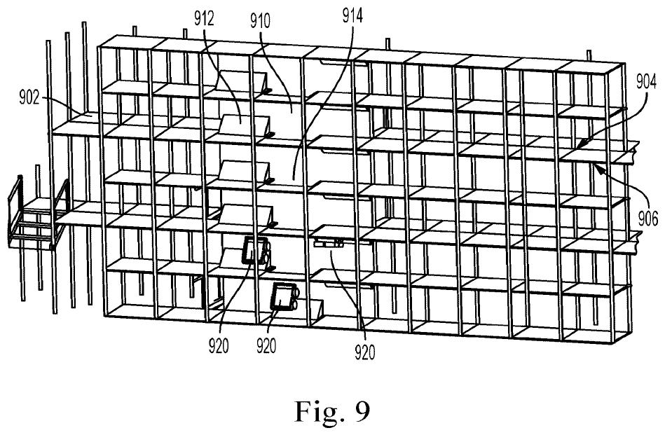

FIG. 9 depicts a portion of an ASRS including walls 910 extending between a plurality of levels 902 of a storage structure. Such an arrangement may be beneficial to allow robots 920 to quickly move between multiple levels of the storage structure. For example, the robots 920 may move from a floor 904 or a ceiling 906 of a particular level 902 onto the walls 810 via wall connecting ramps 912. Moreover, the levels 902 may include openings 914 to permit the robots 920 to move between the levels along the walls 910.

While ramp structures have been described above to permit movement of the robots between levels of a storage system, it should be understood that alternative and/or additional arrangements to move the robots between levels may be employed in some embodiments. For example, and ASRS may include one or more lift or rail structures to permit movement of the robots between levels.

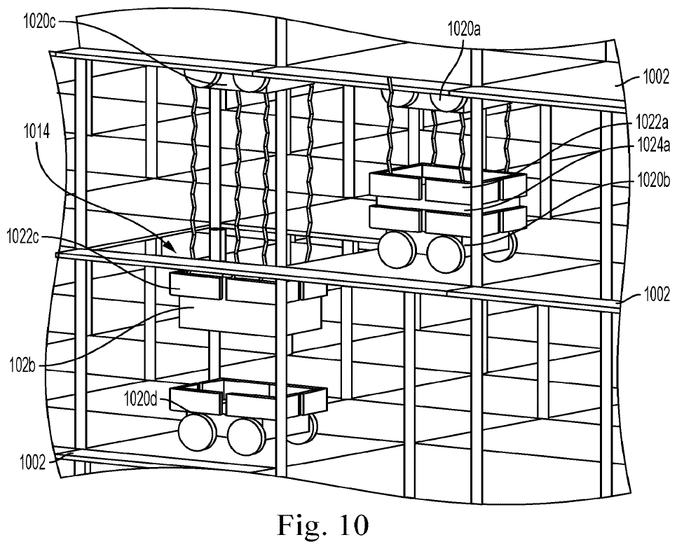

FIG. 10 depicts a portion of an ASRS including first robots 1020a and 1020c traveling on a ceiling of a level 1002, as well as second robots 1020b and 1020d traveling along floors of underlying levels. As illustrated, each of the first robots 1020a and 1020c includes a gripper 1022a and 1022c, respectively, to move a payload 1024a or 1024b between the first robots and the second robots. In particular, the grippers may be configured to grab a payload from an underlying robot to move the payload to a higher level of the storage structure, and/or to release a payload onto the underlying robot to move the payload to a lower level of the storage structure. Moreover, in some instances, the storage structure may include openings 1014 such that the robots may transport a payload across multiple levels.

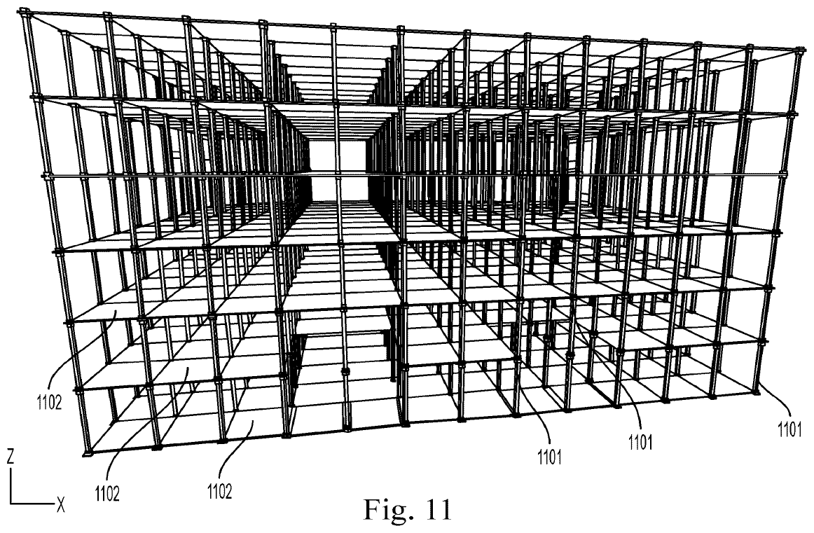

FIG. 11 depicts one embodiment of a model of a storage facility for use with an ASRS. The model may correspond to a proposed grid layout for the storage facility. The model of the storage facility can include information related to the dimensions of the storage facility, locations of any hazard detectors, locations of racks/grids, locations of fire extinguishers, and/or any other obstacles that may be present within the storage facility. The model may also include information related to the height of each level, desired packing density, dimensions of objects to be stored, amount of objects to be stored, and/or locations of human-operated stations. FIG. 11 includes basic racks/grids 1101 and floors 1102, with a total of six levels.

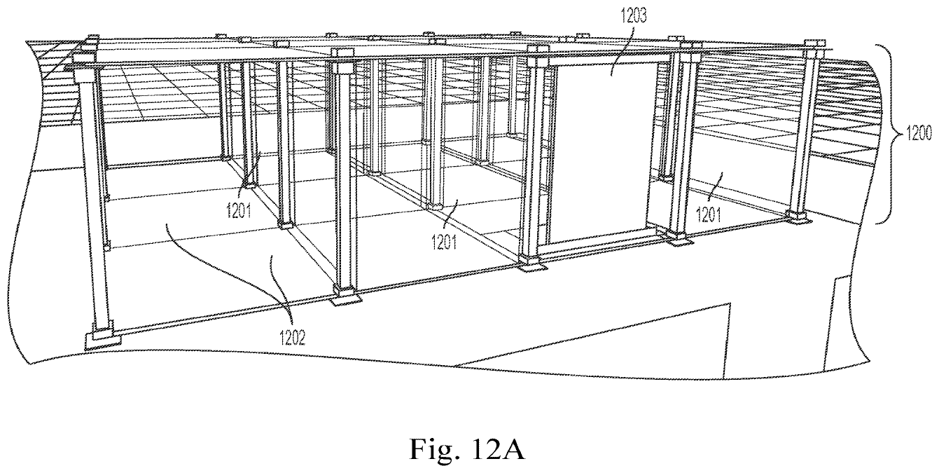

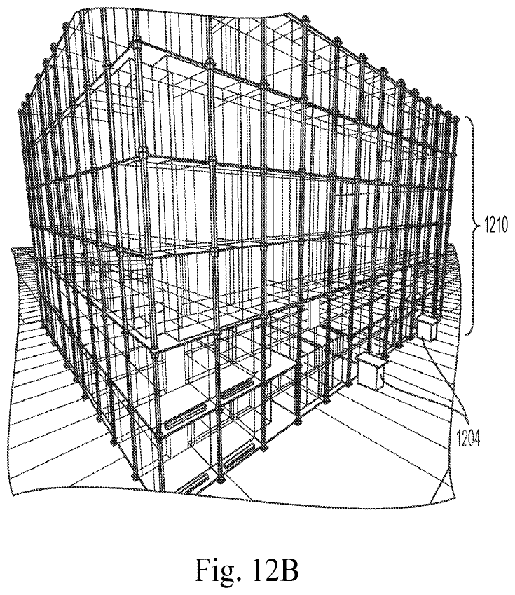

FIG. 12A is one embodiment of a solid model showing cubecells aligned into a grid. The depicted model 1200 contains 4×3×1 grid cells, but a model of a storage facility may contain a greater or lesser quantity of grid cells. The model 1200 has part of its volume partitioned into cubecells 1201. A section of floor 1202 has not yet been partitioned. A vertical wall 1203 is displayed on its reverse side.

FIG. 12B is one embodiment of a solid model showing a medium-sized grid of 12×10×6 grid cells, with 2,700 Cubecells aligned into it. The grid 1210 is almost entirely partitioned into Cubecells, but users may choose to use only a portion of a storage facility's available volume in some embodiments, though instances in which the entirety of a facility's volume is used are also contemplated.

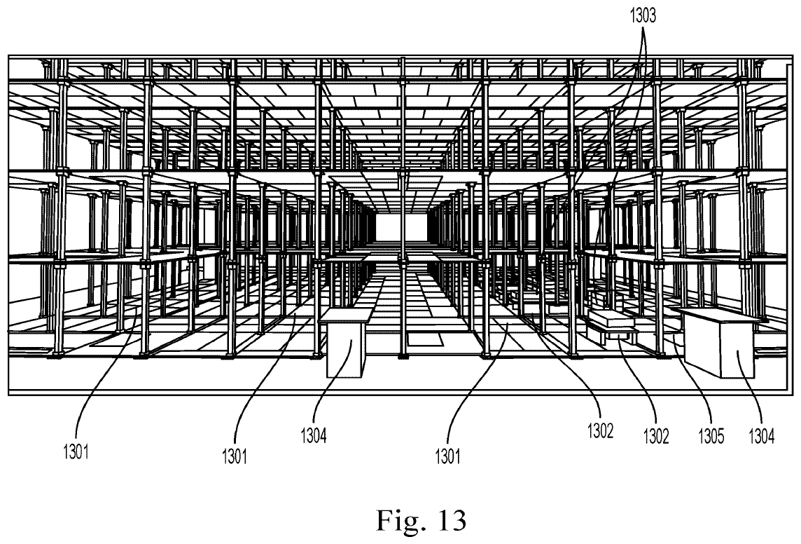

FIG. 13, illustrates one embodiment that has been segmented and had functionalities defined for the various segmented portions of the model using a model similar to that seen in the basic solid model of FIG. 11. For example, the model includes different segmented surfaces including storage surfaces 1303 as shown by the depicted containers, drive surfaces 1301 on which the robots 1302 may travel, workstations 1304 where a human employee may interact with items entering or exiting the ASRS through the workstation, and interface areas 1305 where a robot may interface with another area with a different functionality, such as may the be case with the workstations. In some embodiments, the different segments of interconnected surfaces may be presented to a user using different colors or other appropriate visual representation to distinguish the different functionalities associated with the different surfaces.

### Workflow Example

The following example describes the method of creating a three dimensional model for a ASRS in a storage facility.

Initial parameters of the storage facility as well as user conditions may be collected and a model with the depicted grid layout may be generated through a solid assembly designer with a workflow similar to that shown in FIG. 3A and/or FIG. 3B. In FIG. 11, the initially generated barebone grid of the storage facility is shown. After the grid is generated, interconnected surfaces and volumes of the grid may be defined, segmented, and partitioned. The segmentation process of the interconnected surfaces may correspond to the method shown in FIG. 3C in some embodiments, and the partitioning process of the interconnected surfaces may correspond to the method shown in FIG. 3D in some embodiments. In FIG. 12B, the partitioned volumes of the grid are depicted.

The segments of the interconnected surfaces and partitioned interconnected volumes may be functionalized after being generated as depicted in the workflow shown in FIG. 7A. The model may then be updated to include the generated information related to the interconnected surfaces and functionalities. For example, in FIG. 13, multiple separate surface segments of the depicted interconnected surface associated with different functionalities are illustrated as detailed above.

With the updated model as seen in FIG. 13, simulations using the same control logic to control the individual robots may then be run within the modeled environment to ensure that proper object clearances are maintained during operation of the robots. After confirming that the functionality of the modelled storage system and robotic control algorithms are both accurate and do not generate errors such as collisions between the one or more robots included in the model with each other and/or other features in the model, the generated maps may be used to control operation of robots in the actual storage facility to enable the desired ASRS. Due to the reduced complexities and use of the same control logic as the actual robots, it may be possible to update the model design to either modify a proposed design prior to construction and/or to redefine the functionalities of one or more portions of a storage facility after construction. For example, two primary considerations for a storage facility are throughput speed and storage capacity. Thus, using the disclosed systems and methods, it may be possible to model different functional layouts, different numbers of workstations/amount of storage space, and/or any other desired modification for operation of an ASRS to provide a desired performance for the overall ASRS. Further, in some embodiments, due to the grid like nature of the disclosed storage facilities and corresponding robots, operation of such an ASRS may be easily modified without physically changing the construction of the storage facility offering both cost and time savings relative to existing systems.

The above-described embodiments of the technology described herein can be implemented in any of numerous ways. For example, the embodiments may be implemented using hardware, software or a combination thereof. When implemented in software, the software code can be executed on any suitable processor or collection of processors, whether provided in a single computing device or distributed among multiple computing devices. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Further, it should be appreciated that a computing device including one or more processors may be embodied in any of a number of forms, such as a rack-mounted computer, a desktop computer, a laptop computer, or a tablet computer. Additionally, a computing device may be embedded in a device not generally regarded as a computing device but with suitable processing capabilities, including a Personal Digital Assistant (PDA), a smart phone, tablet, or any other suitable portable or fixed electronic device.

Also, a computing device may have one or more input and output devices. These devices can be used, among other things, to present a user interface. Examples of output devices that can be used to provide a user interface include display screens for visual presentation of output and speakers or other sound generating devices for audible presentation of output. Examples of input devices that can be used for a user interface include keyboards, individual buttons, and pointing devices, such as mice, touch pads, and digitizing tablets. As another example, a computing device may receive input information through speech recognition or in other audible format.

Such computing devices may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the embodiments described herein may be embodied as a computer readable storage medium (or multiple computer readable media) (e.g., a computer memory, one or more floppy discs, compact discs (CD), optical discs, digital video disks (DVD), magnetic tapes, flash memories, RAM, ROM, EEPROM, circuit configurations in Field Programmable Gate Arrays or other semiconductor devices, or other tangible computer storage medium) encoded with one or more programs that, when executed on one or more computers or other processors, perform methods that implement the various embodiments discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computing devices or other processors to implement various aspects of the present disclosure as discussed above. As used herein, the term “computer-readable storage medium” encompasses only a non-transitory computer-readable medium that can be considered to be a manufacture (i.e., article of manufacture) or a machine. Alternatively or additionally, the disclosure may be embodied as a computer readable medium other than a computer-readable storage medium, such as a propagating signal.

The terms “program” or “software” are used herein in a generic sense to refer to any type of computer code or set of computer-executable instructions that can be employed to program a computing device or other processor to implement various aspects of the present disclosure as discussed above. Additionally, it should be appreciated that according to one aspect of this embodiment, one or more computer programs that when executed perform methods of the present disclosure need not reside on a single computing device or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

The embodiments described herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by a “user.” It should be appreciated that a “user” need not be a single individual, and that in some embodiments, actions attributable to a “user” may be performed by a team of individuals and/or an individual in combination with computer-assisted tools or other mechanisms.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

1. A method for generating a model of a storage facility, the method comprising:
obtaining a three-dimensional model of the storage facility;
defining a plurality of interconnected surfaces within the three-dimensional model; and
assigning one or more functionalities to the plurality of interconnected surfaces.

2. The method of claim 1, further comprising segmenting the plurality of interconnected surfaces into a plurality of surface segments and one or more boundaries disposed between adjacent surface segments.

3. The method of claim 1, further comprising generating a map for use by one or more robots based at least in part on the plurality of interconnected surfaces and the one or more functionalities.

4. The method of claim 1, wherein the one or more functionalities include at least one selected from a drivable space, container storage, container handling, and a user workstation.

5. The method of claim 1, further comprising defining a plurality of interconnected volumes within the three-dimensional model corresponding to void space within the model.

6. The method of claim 5, further comprising partitioning the plurality of interconnected volumes into separate partitioned volumes.

7. The method of claim 2, further comprising assigning one or more functionalities to the plurality of interconnected volumes.

8. The method of claim 1, wherein the one or more functionalities of the plurality of interconnected volumes include at least one selected from a drivable space, container storage, container handling, and a user workstation.

9. The method of claim 1, further comprising storing the three-dimensional model in non-transitory computer readable memory.

10. A method for controlling operation of a robot in a storage facility, the method comprising
obtaining a map including information related to a plurality of interconnected surfaces located in the storage facility, wherein the plurality of interconnected surfaces have assigned functionalities;
determining a location of the robot within the storage facility;
identifying an interconnected surface the robot is located on based at least in part on the determined location and the map; and
controlling operation of the robot based at least in part on the determined location and a functionality of the identified interconnected surface the robot is located on.

11. The method of claim 10, wherein the plurality of interconnected surfaces include a plurality of separate surface segments with separately defined functionalities.

12. The method of claim 11, wherein one or more boundaries are disposed between adjacent surface segments.

13. The method of claim 10, further comprising generating the map based at least in part on a three dimensional model of the storage facility.

14. The method of claim 13, wherein the map is generated on the robot.

15. The method of claim 13, wherein the map is generated on a remotely located server.

16. The method of claim 10, further comprising downloading the map to the robot from a remotely located server.

17. The method of claim 10, wherein the assigned functionalities include at least one selected from drivable space, container storage, container handling, and a user workstation.

18. A non-transitory computer readable memory including instructions that when executed by one or more processors perform the method of claim 1.

19. A robot comprising:
a locomotion system configured to move the robot along a surface;
a retainer constructed and arranged to hold a payload;
a controller comprising a processor configured to:
obtain a map including information related to a plurality of interconnected surfaces located in the storage facility, wherein the plurality of interconnected surfaces have assigned functionalities;
determine a location of the robot within the storage facility;
identify an interconnected surface the robot is located on based at least in part on the determined location and the map; and
control operation of the robot based at least in part on the determined location and a functionality of the identified interconnected surface the robot is located on.

20. The robot of claim 19, wherein the plurality of interconnected surfaces include a plurality of separate surface segments with separately defined functionalities.

21. The robot of claim 20, wherein one or more boundaries are disposed between adjacent surface segments.

22. The robot of claim 19, wherein the controller is configured to generate the map based at least in part on a three dimensional model of the storage facility.

23. The robot of claim 22, wherein the controller is configured to download the map to the robot from a remotely located server.

24. The robot of claim 19, wherein the map is stored on non-transitory computer readable memory on the robot.

25. The robot of claim 19, wherein the assigned functionalities include at least one selected from drivable space, container storage, container handling, and a user workstation.
